(19) United States
(12) Patent Application Publication
(10) Pub. No.: US 2022/0242734 A1
(43) Pub. Date: Aug. 4, 2022

(54) Densified Reduced Graphene Oxide and Methods of Production

(71) Applicant: Cabot Corporation, Boston, MA (US)

(72) Inventors: Limeng Chen, Arlington, MA (US); John L. Gallagher, Hubbardston, MA (US); Yakov E. Kutsovsky, Arlington, MA (US); Agathagelos Kyrlidis, Cambridge, MA (US)

(21) Appl. No.: 17/613,742

(22) PCT Filed: Jun. 4, 2020
(86) PCT No.: PCT/US2020/036193

§ 371 Date: Nov. 23, 2021

Related U.S. Application Data
(60) Provisional application No. 62/857,296, filed on Jun. 5, 2019.

(51) Int. Cl. C01B 32/192; C01B 32/194; C08J 3/22; C08K 3/04

(52) U.S. Cl. CPC C01B 32/192; C01B 32/194; C01P 2004/61; C08K 3/046; C08J 3/226

(57) ABSTRACT

Methods for the production of densified granules of graphene oxide worm (rGOW) particles. Graphene oxide worms are combined with a liquid to produce densified granules of graphene oxide worms. The granules can be easily processed and can incorporated into polymeric compositions such as elastomers. Also disclosed are masterbatch and composite materials made by combining the granules with a polymer.

### FIELD OF THE DISCLOSURE

This disclosure relates to graphene oxide, and in particular, to densified reduced graphene oxide and methods of production.

### BACKGROUND

Graphene can be oxidized to form graphene oxide particles that include oxygen atoms covalently bonded to the carbon lattice. Graphene oxide in turn can be reduced fully or partially to produce a composition known as reduced graphene oxide (rGO). Reduced graphene oxide has different properties than both graphene and graphene oxide and can be combined with other materials such as polymers to improve the properties of the material.

### SUMMARY

In one aspect, granules are provided, the granules comprising reduced graphene oxide worm particles and at least 50% liquid, by weight, wherein the granules have a density greater than 0.02 g/cc. The granules can comprise additional particles selected from one or more of carbon nanotubes, graphite, carbon black, silica and clays. In some cases, the granules can consist essentially of reduced graphene oxide worm particles and liquid. The granules can comprise at least 1.0% by weight of reduced graphene oxide worm particles and the liquid can comprise a water miscible solvent, water, an alcohol, a glycol, an ether, an aldehyde, an aromatic hydrocarbon or an aliphatic hydrocarbon. The granules can have an average aspect ratio less than the average aspect ratio of the rGOW particles in the granules. The granules can be retained and processed in a polymer bag. A masterbatch can be produced by combining the granules with a polymer. The reduced graphene oxide worm particles can have an oxygen content of greater than 0.1%, greater than 0.5%, greater than 1.0%, greater than 5.0%, greater than 10.0%, greater than 14.0%, less than 25%, less than 15%, less than 10%, less than 5.0%, less than 3%, less than 2% or less than 1.0%.

In another aspect, a method for producing densified carbonaceous granules is provided, the method comprising combining a carbonaceous material with a liquid, the carbonaceous material having a density of less than 0.01 g/cc and comprising particles having an average aspect ratio of greater than 3:1, the densified carbonaceous granules having a density at least five times greater than the density of the carbonaceous material. The carbonaceous material can be reduced graphene oxide worm structures or carbon nanotubes. The method may include further combining a second material with the liquid, the second material different from the carbonaceous material and selected from carbon nanotubes, graphite, carbon black, silica and clay. The liquid can have a boiling point below 120° C. at atmospheric pressure. The liquid can comprise water and the weight ratio of liquid to carbonaceous material can be greater than 3:1, greater than 4:1, greater than 5:1, greater than 6:1, greater than 10:1, or greater than 50:1. A polymeric masterbatch can be made by mixing any of the densified carbonaceous granules with a polymer. The masterbatch can be made by placing a polymer bag containing the densified carbonaceous granules into the polymer and incorporating the bag and densified carbonaceous granules into the polymer. The masterbatch can include a second polymer, the second polymer being the same as or different from the polymer. The densified carbonaceous granules can have an average aspect ratio of less than 3:1, less than 2:1 or less than 1.5:1 and a density greater than 0.02 g/cc, 0.03 g/cc, 0.05 g/cc or 0.1 g/cc. The method can include adding a second densified material wherein the second densified material is densified independently of the densified carbonaceous granules. The method can include adding a second densified material wherein the second densified material is densified in the same process as the densified carbonaceous granules. The second densified material can be one or more of graphene, carbon nanotubes, silica and clay. The polymer may be an elastomer.

In another aspect, a method of making a polymer composite is provided, the method comprising combining reduced graphene oxide worms with a polymer in a volume ratio of less than 2:1 or less than 1:1 to produce a polymer composite having a reduced graphene oxide worm content of greater than 2% by weight. The resulting polymer composite can include a reduced graphene oxide worm content of greater than 3%, greater than 5% or greater than 10% by weight.

In another aspect, a method of making a polymer composite is provided, the method comprising combining reduced graphene oxide worms with a polymer in a volume ratio of less than x:1 to produce a polymer composite having a reduced graphene oxide worm content of greater than x %, greater than 2×%, greater than 3×% or greater than 5×% by weight. The reduced graphene oxide worms can be granulated and can comprise at least 50% by weight of a liquid having a boiling point of less than 120° C. The method can include removing at least 75% of the liquid from the polymer composite by evaporation, and liquid can be evaporated by using thermomechanical mastication, by using external heating or via application of vacuum. A second particulate material can be added to the elastomer composite and may be added separately from the reduced graphene oxide worms. The polymer can be an elastomer.

In another aspect, granules are provided, the granules including reduced graphene oxide worm particles and at least 50% liquid, by weight. The granules are free flowing and are non-contiguous. They may include particles selected from one or more of carbon nanotubes, graphite, carbon black, silica and clays. The granules can consist essentially of reduced graphene oxide worm particles and liquid. They may comprise at least 1.0% by weight of reduced graphene oxide worm particles. The liquid can be water, a water miscible solvent, an alcohol, a glycol, an ether, an aldehyde, an aromatic hydrocarbon or an aliphatic hydrocarbon. The granules may have an average aspect ratio less than the average aspect ratio of the rGOW particles of which the granules are comprised or less than 3:1. The oxygen content of the reduced graphene oxide worm particles can be, by weight, greater than 0.1%, greater than 0.5%, greater than 1.0%, greater than 5.0%, greater than 10.0%, greater than 14.0%, less than 25%, less than 15%, less than 10%, less than 5.0%, less than 3%, less than 2% or less than 1.0%. The granules can be packaged in a polymer bag. The granules can be incorporated into a polymer masterbatch. The granules may have an average diameter of 10 μm to 100 μm, 100 μm to 1 mm, 10 μm to 1 mm, 100 μm to 3 mm, 500 μm to 2 mm, 1 mm to 3 mm or 1 mm to 5 mm and may exhibit a standard deviation that is less than 50%, less than 20% or less than 10% of the average diameter. The granules may have a density of greater than 0.02 g/cc, 0.03 g/cc, 0.05 g/cc or 0.1 g/cc.

In another aspect, a method of making a composite includes combining a polymer with a granule comprising reduced graphene oxide worm particles and at least 50% liquid, by weight, and dispersing the reduced graphene oxide worm particles in the polymer to produce a polymer composite. The method can include mixing in particles selected from one or more of carbon nanotubes, graphite, carbon black, silica and clay. The polymer can be selected from elastomers, thermoplastics, polyurethanes, polysiloxanes and fluorinated polymers. The thermoplastic can be selected from one or more of polyethylene, polypropylene, polycarbonate, acrylonitrile butadiene styrene, polyamides, polyaramides, polystyrene and polyacrylates. In the case of an elastomer, the elastomer can be selected from natural rubbers and polymers of 1,3-butadiene, styrene, isoprene, isobutylene, 2,3-dialkyl-1,3-butadiene, wherein alkyl may be methyl, ethyl, propyl, acrylonitrile, ethylene and propylene. In some cases, the elastomer is selected from styrene butadiene (SBR), polybutadiene (BR), acrylonitrile butadiene (NBR), highly saturated nitrile rubber (HNBR), fluoroelastomers (FKM and FEPM) and polyacrylate (ACM). The method can include removing more than 50%, more than 75%, more than 90%, more than 95% or more than 99% of the liquid from the composite. The liquid can be evaporated from the composite during the mixing process. The granules can be provided in a polymer dosage bag. The composite can include rGO worms at a concentration of greater than 2%, greater than 5%, greater than 10%, greater than 20% or greater than 30% by weight. The method can comprise mixing the polymer composite with a second polymer that may be the same or different from the polymer. The concentration of reduced graphene oxide worms, by weight, in the composite can be from 0.1% to 50%, 0.1% to 40%, 0.1% to 30%, 0.1% to 20%, 0.1% to 10%, 1% to 50%, 1% to 30% or 1% to 10%.

In another aspect, a method of making a granule is described, the method comprising combining fluffy reduced graphene oxide worms with a liquid, and granulizing the reduced graphene oxide worms and the liquid to produce reduced graphene oxide worm granules. The liquid can comprise water, and the liquid can account for greater than 50%, greater than 75% or greater than 90% of the granule, by weight. The mass of liquid to the mass of reduced graphene oxide particles can be greater than 2:1, greater than 3:1, greater than 5:1 or greater than 10:1. The ratio of the mass of liquid to the mass of reduced graphene oxide particles can be less than 15:1, less than 10:1, less than 7:1 or less than 5:1. The granules can be formed by rolling the mixture of reduced graphene oxide worm particles and the liquid. The volume of the fluffy reduced graphene oxide worm particles can be reduced by a factor of greater than 3, greater than 5, greater than 10 or greater than 20. A second particulate material can be mixed with the reduced graphene oxide worm particles and the liquid. The second particulate material can be selected from carbon nanotubes, graphite, carbon black, silica and clay. The liquid can be water and can be essentially void of other liquids. The liquid may comprise a mixture of two different liquids. A binder may be mixed in with the reduced graphene oxide worm particles and the liquid.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended to limit the scope of the disclosure. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1a is a schematic representation of a graphite particle;

FIG. 1b is a schematic representation of a reduced graphene oxide worm particle; and

FIG. 2 is a scanning electron microscopy (SEM) photograph of a reduced oxide worm particle.

General Overview

Reduced graphene oxide (rGO) particles, such as rGO worms, typically are in powder form and have a low density of less than 10 g/L or less than 5 g/L. This bulky powder (referred to as fluffy material) can be difficult to handle and can form airborne dust when the powder is transferred. Described herein are processes for making densified rGO granules that can be, for example, five times as dense as the fluffy rGO powder. These densified granules can be incorporated directly into polymeric materials without incurring many of the problems associated with the direct transfer of rGO powder.

The densified granules can comprise any type of graphene based particle, such as rGO worms. This disclosure is directed primarily to rGO worms, but it is understood that the densification techniques may be applicable to other particulate structures as well. For example, these densification techniques may be used with carbonaceous particles such as carbon nanotubes, graphenes, functionalized graphenes, graphene oxides and reduced graphene oxides. Other materials can be incorporated into the granules along with the carbonaceous particles. These materials can include fillers such as clay and metal oxides including silica and alumina.

In various embodiments, fluffy rGO worm particles are combined with a liquid to produce densified granules. The liquid may be a single compound or may be a mixture of compounds. In a specific set of embodiments, the liquid is water. The liquid and fluffy rGO worm particles are combined and pelletized, for example, in a pelletizer. The resulting granules comprise both the liquid and rGO particles (e.g., worms). Despite a large proportion of liquid (e.g., >75% by weight) in the granules, the granules can be free flowing and are not wet to the touch. In many cases, under ambient storage conditions the granules retain the liquid and there is no visible (to the naked eye) evidence of free liquid separating from the granules. The liquid may, however, separate from the granule through evaporation as a gas (e.g., a vapor), freeze drying or via solvent extraction.

The densified granules are easy to store, transport and handle. They may be added to polymeric materials to form polymer composites including the polymer and the rGO particles. For example, densified granules of rGO worms can be added to an elastomer and mixed into the elastomer using less than half the volume of rGO worms compared to adding un-densified rGO powder. During mixing, the granules are broken apart and the rGO worms become disassociated from each other and are dispersed in the matrix. As a result, the rGO worm loading in the polymer composite can be greater than what can be achieved with undensified fluffy rGO worm particles. The granules can be added to the elastomer with a minimum of dust formation. In some embodiments, the granules are added in a dosage bag that can become incorporated into the elastomer.

The densified granules of rGO worms are easy to process yet can preserve the properties of the fluffy rGO worm particles. When mixed with a polymer, for instance, the granules break up into individual rGO worm particles that can disperse evenly throughout the matrix. Processing can be completed without exfoliation of the graphene sheets. It is believed that the rGO worms that have been densified in a granule retain most or all of their original morphology. For example, although difficult to measure, it is believed that the densified rGO worms can exhibit a BET surface area that is unchanged or is more than 80% or more than 90% of the surface area of the original undensified rGO worms. Similarly, it is believed that particle structure, as measured by effective OAN can be retained at more than 70%, more than 80% or more than 90% of the OAN of the original undensified particles. As a result, the rGO worms can be densified, transported and incorporated into a polymer system and exhibit the same functionality as if they had never been densified.

### DETAILED DESCRIPTION

Reduced Graphene Oxide Worm Structures

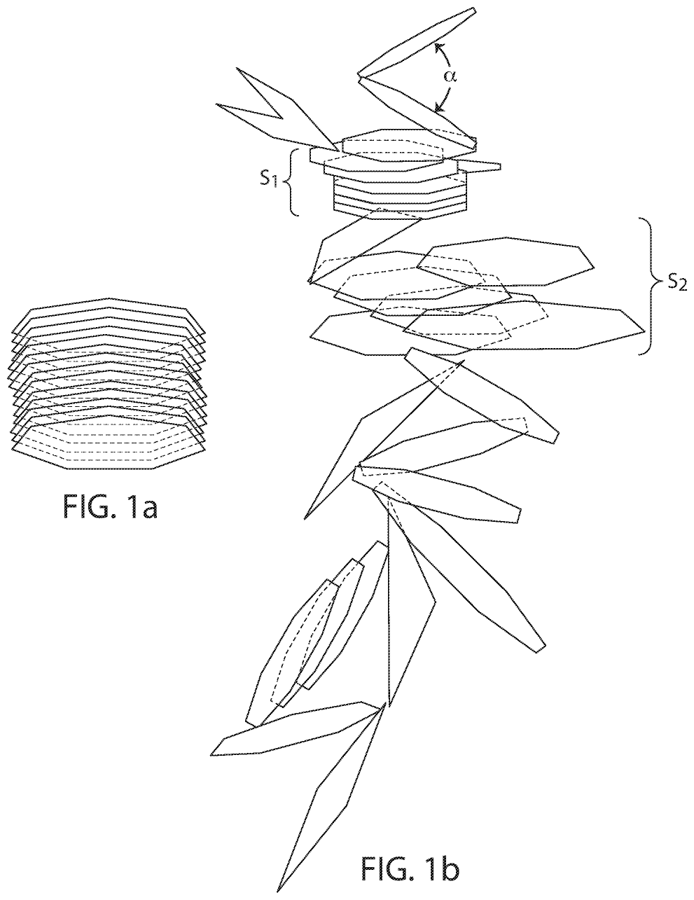

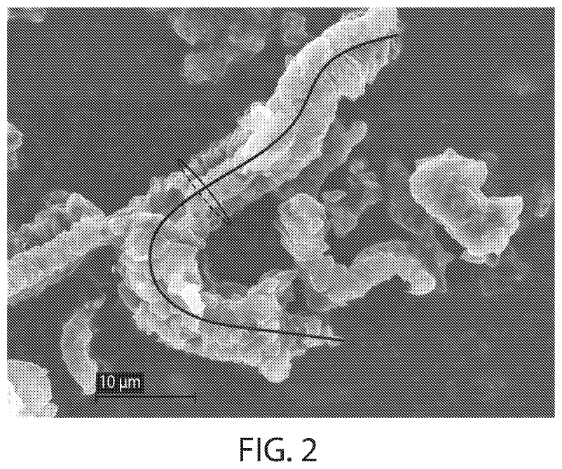

An rGO worm particle (rGOW) is a monolithic particle that can comprise any number of platelets of reduced oxidized graphenes. At least some of the platelets are in a plane that is not parallel with that of an adjacent platelet. See a schematic representation in FIG. 1b. Although the rGOW platelets are referred to as planar, they are typically not as planar as, for example, graphene sheets (FIG. 1a), but rather include wrinkles and deformities that result from the oxidation/reduction processes by which the particles have been treated. As a result, the rGOW platelets are thicker than graphene sheets although they still retain a generally planar shape having a diameter that is several times greater than the thickness of the platelet. As can be seen in the SE micrograph of FIG. 2, these platelets include multiple sub-sections that are at distinct angles to each other. This unevenness contributes to the high surface area and low bulk density of the particles.

An adjacent platelet is defined as a platelet that is joined directly to a given platelet on either major side of the given platelet. A platelet is not adjacent if it is joined to the given platelet via only a third platelet. A platelet may be at an angle to a first adjacent platelet on one side and retain a parallel structure with a second adjacent platelet on the opposed side. Many of the platelets in a rGOW structure can remain in a graphite configuration in which they are parallel to each other and remain bound together by van der Waals forces. For example, see stacks s1 and S2 in FIG. 1b. Particles of rGOW do not typically have extensive graphitic structures, and different embodiments of rGOW structures may be limited to parallel platelet composite structures containing fewer than 15, fewer than 12, or fewer than 11 adjacent parallel platelets. Reduced graphite oxide worm particles exhibit a structure where any dimension of the particle, such as length or diameter, is greater than the thickness of the sum of all the graphene platelets that comprise the particle. For example, if the thickness of a single graphene platelet is about 1 nm, then an rGOW particle comprising 1,000 platelets would be greater than 1 micron in both length and diameter. These three-dimensional particles also have a dimension of at least 50 nm along each of the x, y and z axes as measured through at least one origin in the particle. An rGOW particle is not a planar structure and has a morphology that distinguishes it from both graphite (stacks of graphene platelets) and individual graphene sheets. It is notable however, that rGOW particles can be exfoliated into single platelets, or stacks of platelets, and that these platelets can have at least one dimension that is less than 5, less than 10, less than 50 or less than 100 nm. After an rGOW particle has been exfoliated, the resulting single platelets or stacks of parallel platelets are no longer rGOW particles.

The rGOW particles described herein can comprise a plurality of graphene platelets and in various embodiments may include greater than 10, greater than 100 or greater than 1000 graphene platelets. In various embodiments, the particles may be linear or serpentine, can take roughly spherical shapes, and in some cases may be cylindrical. The structure of an rGOW particle can be described as accordion-like because of the way the particle expands longitudinally due to the alternating edges at which the platelets remain joined. For example, as shown in FIG. 1b, at least some of the adjacent graphene planes are not parallel and are at angles to each other (e.g., angle α in FIG. 1b), for example, at about 25°. Various embodiments may include one or more pairs of adjacent graphene platelets that are joined at angles of, for example, 10°, 25°, 35°, 45°, 60° or 90°. Different adjoining pairs of graphene platelets may remain joined at different edges or points, so the graphene platelets are not necessarily canted in the same direction. If the adjacent graphene platelets remain attached randomly to each other at platelet edges after expansion, the particle will extend in a substantially longitudinal direction. These elongated, expanded, worm-like structures can have an aspect ratio that can be greater than 1:1, greater than 2:1, greater than 3:1, greater than 5:1 or greater than 10:1. The longer axis, or length, of an rGOW particle is the longest line that passes through a central longitudinal core of the particle from one end to the other. See FIG. 2. This line may be curved or linear, or have portions that are curved or linear, depending on the specific particle. The line runs substantially normal to the average c-plane of the platelets in any particular portion along the line. The shorter axis, diameter or width, of the particle is deemed to be the diameter of the smallest circle that can fit around the particle at its midpoint. See FIG. 2. In various embodiments, the length of an rGOW particle can be greater than 1.0 μm, greater than 2.0 μm, greater than 5.0 μm, greater than 10 μm or greater than 100 μm. In the same and other embodiments, the width (diameter of the circle shown in FIG. 2) can be, for example, less than 100 μm, less than 50 μm, less than 20 μm, less than 10 μm, less than 5 μm or less than 2 μm. Specific diameter ranges include: greater than 50 nm, greater than 100 nm, greater than 1 μm, greater than 10 μm, greater than 100 μm, 100 nm to 100 μm, 500 nm to 100 μm, 500 nm to 50 μm, 2.0 μm to 30 μm, 2.0 μm to 20 μm, 2.0 μm to 15 μm, 2.0 μm to 10 μm, 1.0 μm to 5 μm, 100 nm to 5 μm, 100 nm to 2 μm, 100 nm to 1 μm, less than 200 μm, less than 100 μm or less than 10 μm. The width of an rGOW particle along its length need not be constant and can vary by a factor of greater than 2×, greater than 3×or greater than 4×.

An rGOW particle may contain carbon, oxygen and hydrogen and may be essentially void of other elements. A particle is essentially void of an element if the element is absent or is present only as an impurity (e.g., less than 10 wt %). In specific embodiments, an rGOW particle can comprise greater than 80%, greater than 90%, greater than 95% or greater than 99% carbon by weight. Some particles may include oxygen, and particularly covalently bound oxygen, at concentrations by weight of greater than 0.1%, greater than 0.5%, greater than 1.0%, greater than 5.0%, greater than 10.0%, greater than 14.0%, less than 25%, less than 15%, less than 10%, less than 5.0%, less than 3%, less than 2% or less than 1.0%. Hydrogen content may be greater than 0.1% or greater than 1% by weight. In the same and other embodiments, hydrogen content may be less than 1%, less than 0.1% or less than 0.01% by weight. In some embodiments, heteroatoms such as nitrogen or sulfur may be present at greater than 0.01% or greater than 0.1% by weight.

Reduced graphite oxide worm particles can exhibit a low density. For example, in various embodiments the particles may have a bulk density of less than 100 g/L, less than 50 g/L, less than 30 g/L, less than 20 g/L, less than 10 g/L, less than 5 g/L, greater than 5 g/L, greater than 10 g/L or greater than 15 g/L when measured using ASTM D7481-09. These particles may also exhibit high surface area and in some embodiments, can have BET (Brunauer, Emmett and Teller, ASTM D6556-10) surface areas of greater than 200 m²/g, greater than 300 m²/g, greater than 400 m²/g, greater than 500 m²/g, greater than 600 m²/g, greater than 700 m²/g, greater than 900 m²/g or greater than 1000 m²/g. The rGOW particles may also exhibit high structure, and when measured using oil absorption number (OAN) can exhibit structures of greater than 500 mL/100 g, greater than 1000 mL/100 g, greater than 1500 mL per 100 g or greater than 2000 mL per 100 g.

One indicator of the oxygen content in a reduced graphene oxide particle is the volatile material content of the particle. In various embodiments, the rGOW particles can have a volatile content by thermogravimetric analysis (TGA), from 125° C. to 1000° C. under inert gas, of greater than 1%, greater than 1.5%, greater than 2.0%, greater than 2.5%, greater than 5%, greater than 10%, greater than 15% or greater than 20%. In the same and other embodiments, the volatile content by the same technique can be less than 30%, less than 25%, less than 20%, less than 15%, less than 10%, less than 5%, less than 3% or less than 2%.

The oxygen content of the rGOW particles, when compared to the parent graphite oxide, can be reduced by greater than 25%, greater than 50% or greater than 75%. Similarly, the energetic content of the particles upon thermal decomposition (as measured by differential scanning calorimetry) can be reduced by, for example, greater than 25%, greater than 50% or greater than 75%. The decomposition energy of the rGOW particles can be, for example, less than 150 J/g, less than 100 J/g, less than 50 J/g or less than 20 J/g.

The graphitic structure of an rGOW particle can be investigated by Raman spectroscopy. Pure graphite has a Raman spectrum with a strong G band (1580 cm′) and non-existent D band (1350 cm⁻¹). Graphite oxide exhibits a strong D band as well as G band. Reduced graphite oxide and rGOW particles have a strong D band that in many cases is stronger than the G band (FWHM). In some embodiments, the ratio of the D band to G band may be greater than 1.0, greater than 1.1 or greater than 1.2.

Particles of rGOW can often be differentiated from graphite and similar materials due to differences in crystallinity. Crystallinity of rGOW particles can be determined by Raman spectroscopy and in various embodiments the rGOW particles can exhibit crystallinity values of less than 40%, less than 30% or less than 20%. X-ray diffraction can also be helpful in differentiating between graphite and materials such as graphite oxide and rGOW particles that exhibit different interlayer spacing than does graphite. Graphite has a strong XRD peak between 25° and 30°, however rGOW particles typically have no discernible peak in this range. For example, between 25° and 30°, rGOW particles may have an undetectable peak or a peak that is less than 10% or less than 5% of that of graphite particles.

Reduced graphene oxides are further described in PCT Publication WO 2016/126596, filed on Feb. 1, 2016, and titled “Urea Sequestration Compositions and Methods,” the contents of which are hereby incorporated by reference herein. For instance, the '596 application discloses methods of production and describes specific compositions and morphologies of reduced graphene oxides, which are incorporated by reference herein.

Densification

Reduced graphene oxide worms, as produced, typically take the form of a light, low density fluffy powder. These small particles easily form airborne dust when they are transferred from one container to another. As mentioned above, the particles may have a bulk density (ASTM D7481-09) of less than 10 g/L or less than 5 g/L. As described herein, this low-density powder can be combined with a liquid to form densified granules. Volume for volume, compared to the as made fluffy powder, the granules may contain more than 2×, more than 3×, more than 4×or more than 5×the mass of rGO. For example, the density of the rGO component of the granule can be greater than 0.02 g/cc, 0.03 g/cc, 0.05 or 0.1 g/cc. The composite granules themselves (including liquid and solid components) can, in various embodiments, have a density of greater than 0.05 g/cc, greater than 0.1 g/cc, greater than 0.2 g/cc or greater than 0.3 g/cc. In alternative terms, this means that the bulk density of the granule can be more than 5×, more than 8×or more than 10×the density of the fluffy low-density rGO powder. The ratio of rGO particles to liquid in the granules, by weight, can be greater than 1:20, greater than 1:10, greater than 1:5, greater than 1:2, less than 1:1, less than 1:2, less than 1:5, less than 1:10 or less than 1:50. The preferred amount of liquid can be the minimum amount required to get granules to form during the densification process.

Densified granules of rGO worms, or other carbonaceous materials, can be of substantially uniform size. The diameter of a granule is defined as the diameter of the smallest sphere that will enclose the granule. Individual granules may have a diameter of, for example, 10 μm to 100 μm, 100 μm to 1 mm, 10 μm to 1 mm, 100 μm to 3 mm, 500 μm to 2 mm, 1 mm to 3 mm or 1 mm to 5 mm. Similarly, a plurality of granules may have an average diameter (arithmetic mean) of, for example, 10 μm to 100 μm, 100 μm to 1 mm, 10 μm to 1 mm, 100 μm to 3 mm, 500 μm to 2 mm, 1 mm to 3 mm or 1 mm to 5 mm, and the average diameter of the group can exhibit a standard deviation that is less than 50%, less than 20% or less than 10% of the average diameter. In some embodiments, the granules are made of rGO particles, and the granules may have a diameter that is larger than the length of the rGO particles that comprise the granule by a factor of >10×, >100× or >1,000×. The densified granules may have a substantially uniform shape and an average aspect ratio of less than 3:1, less than 2:1 or less than 1.5:1. The aspect ratio of a granule is determined by taking the ratio a:b of the longest cross-sectional length (a) of the granule to the length of the shortest cross-sectional length (b) of the granule where (b) passes through the midpoint of (a) and is normal to (a). Note that length “a” is equal to the diameter of the granule. The shape and size of the granules help contribute to their flowability. In many embodiments, the granules can be poured like dry sand, without significant adhesion between the granules. As used herein, granules are “flowable” if they can be poured from a container without sticking to the container walls or to adjacent granules.

A variety of liquids can be used to from the granules. Liquids may be chosen, for example, based on their boiling point, their compatibility with a polymer system or based on safety and environmental considerations, such as toxicity, flammability or flashpoint. In some applications, the liquid is removed from the granule, for example, by evaporation. For instance, if the granules are incorporated into an elastomer, the elastomer can be heated to drive off the liquid through evaporation. In some cases, the heat is provided by thermomechanical mastication. In other cases, the mixing vessel can be heated using an external heat source. When evaporation is to be used to drive off the liquid, a low boiling point liquid can reduce the time and energy required. When the granules are to be incorporated into an elastomer, the liquid can have a boiling point that is below the target mixing temperature for the elastomer. For instance, the liquid may have a boiling point of less than 170° C., less than 160° C., less than 150° C., less than 120° C., less than or equal to 100° C., less than 75° C. or less than 50° C. The liquid may be non-toxic and environmentally acceptable. Examples of appropriate liquids include water and organic solvents such as alcohols, glycols, ethers, aldehydes and aromatic and aliphatic hydrocarbons. These liquids, and others, can be used independently or can be mixed together in various ratios. In some cases, particularly in polymer compositions where the liquid will be evaporated off, water is the preferred liquid for producing granules.

The rGO worms can be mixed with a liquid and granulized using equipment capable of effectively combining the particulate and liquid components. For example, the components can be combined and granulized in pelletizing equipment such as a pelletizer, granulator, drum roller, or other equipment capable of forming the rGO worms and liquid into granules. In differing embodiments, the rGO particles can be added to the liquid or the liquid can be added to the particles. The rGO particles and the liquid can be added independently in a single step or can be divided into two or more steps. In some cases, liquid can be added to the rGO material until a granule of desired density, size, shape and flowability is formed. Although in some cases the granules may be exclusively rGO worms and a liquid, in other embodiments they may also contain one or more additional fillers or additives. Additional materials include carbonaceous materials such as graphite, graphene, graphene oxide, carbon black, carbon nanotubes, and carbon-silica hybrid particles such as those described in U.S. Pat. No. 6,057,387, which is incorporated by reference herein. Carbon-silica hybrid particles contain both a carbon phase and a silicon-containing species in a single particle. For example, the particle may be a silica coated carbon particle or a carbon coated silica particle. Non-carbonaceous materials include metal oxides such as silica and alumina, clay, pigments, binders, and additives such as wetting agents, plasticizers and dispersants. These additional materials may be mixed dry with the rGO powder or may be added during the granulation process. In some cases, these additional components may be dissolved, suspended or dispersed in a liquid that can be the same liquid used to form the granules. For example, a 25% (wt) carbon black aqueous slurry can be drum rolled with rGO worm powder at a ratio of 4:1 (wt/wt) to produce a densified granule comprising 20% carbon black, 20% rGO worms and 60% water by weight. The densification process granulizes the rGO worm particles as they come in contact with the liquid and is in contrast to a wet mixing procedure where materials are mixed together in a liquid phase. In the densification process, the particles are not dispersed or suspended in a liquid phase prior to granulization.

In one set of embodiments, liquid is added to rGO powder in a drum at a weight ratio of, for example, 2:1, 3:1, 4:1, 6:1, 10:1, 50:1 or 100:1. The components may be combined in any order, and in some cases portions of the rGO powder or portions of the liquid may be added in separate stages. The drum can be rolled on a drum roller at a speed of 20 to 100 rpm for 2 to 4 hours. The resulting granules may have an average diameter of from about 10 μm to about 1 mm are flowable, and can be transferred to a vapor tight container, such as a polymer dosage bag, without the production of rGO dust. The granules can be stored at room temperature in a container that prevents the granules from drying out.

The densified granules may be used in a number of applications, and in one set of embodiments the granules can be incorporated into a polymer composite. These polymers include elastomers, thermoplastics, polyurethanes, polysiloxanes, fluorinated polymers, and other functionalized polymers, such as those described in US 2015-0183962A1. Specific thermoplastics include polyethylene, polypropylene, polycarbonate, acrylonitrile butadiene styrene, polyamides, polyaramides, polystyrene and polyacrylates. As used herein, an elastomer is an amorphous polymer that be elastically deformed without permanent damage to its shape. Exemplary elastomers include, but are not limited to, natural rubbers, synthetic rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, and propylene and the like. Specific elastomers include styrene butadiene (SBR), polybutadiene (BR), acrylonitrile butadiene (NBR), highly saturated nitrile rubber (HNBR), epoxidized natural rubber, butyl rubber, EPDM (ethylene propylene diene monomer (M-class) rubber, fluoroelastomers (FKM and FEPM) and polyacrylate (ACM). Granules may be added to the elastomer directly, to an elastomer latex, or as part of a masterbatch. Masterbatches can be mixed with additional elastomer that may be the same or different from the elastomer of the masterbatch. Masterbatches may contain concentrations of rGO worms that are greater than 5%, greater than 10%, greater than 20% or greater than 30% of the weight of the masterbatch. In some examples, the granules may be delivered into the elastomer via a dosage bag. A dosage bag can be made of any material that is compatible with the elastomer and can store the granules. Examples of these dosage bag materials include polyethylene and ethylene vinyl acetate (EVA). The amount of elastomer can be selected so that a single dosage bag or a multiple number of dosage bags achieves the desired rGO worm concentration in the compounded elastomer.

In one set of embodiments, densified rGO granules comprising rGO worms and water can be combined with an elastomer in a Banbury mixer with a mixing volume of 1.6 liter and a fill factor of 70%. The walls and rotor of the mixer can be pre-heated to a temperature of 60-110° C., for example. Two thirds of the elastomer can be added to the mixing chamber and masticated for 30 seconds at a rotor speed of 80 rpm. The rotor speed can be reduced to 40 rpm and ethylene-vinyl acetate dosage bags of rGO granules can be fed one at a time into the mixing chamber. Before each dosage bag was loaded, the ram of the mixer can be raised to provide a path to the mixing chamber. After each bag was added, the ram can be lowered to force incorporation of the bag into the elastomer melt. After all the bags were added, that final third of the elastomer can be added, the ram can be lowered to seal the chamber, and the rotor speed can be increased to increase mixing power. The thermomechanical mixing could raise the temperature of the elastomer mix to greater than 100° C. causing the water component of the granules to boil off. To allow the escape of this water vapor, the ram can be raised several times during the process. Antioxidants and other additives may be added at any time during the process to prevent degradation of the elastomer at high temperatures and levels of shear. Once the target temperature is reached, the compounded mixture can be discharged from the mixer and milled into sheets using a two roll mill. Target temperatures may be about 160-170° C.

### EXAMPLE 1

Plastic Composite Example:

Preparation of densified rGO granules comprising rGO worms, water and plastic additives:

In a 500 ml wide mouth plastic bottle, the following ingredients were added in the following order:

| Ingredient | Weight (gram) |
|---|---|
| rGO worms | 2 |
| Irganox ® 1010 Antioxidant | 0.125 |
| Licowax ® OP wax | 1 |
| Carnauba wax | 0.2 |
| Mineral oil (from Sigma Aldrich) | 4 |
| Deionized water | 8 |

The rGO worms can be prepared according to the methods described in PCT Publ. No. WO 2019/070514A1, the disclosure of which is incorporated herein by reference. The density of the rGO worms (rGOW) was 0.005 g/cm³. The original volume of 2 grams of rGOW was 400 mL.

After all ingredients were added, the bottle was tightly capped, placed on top of two rolls of a jar milling machine (U.S. Stoneware), and rolled for two hours at a roller speed of 185 rpm. The volume of the resulting densified rGO granules was approximately ten times less than the volume of the original rGO worms.

Preparation of Polypropylene Compound:

To make a polymer composite comprising a thermoplastic, the densified rGO granules were mixed with polypropylene (HIVAL® 2420NA) in a melt mixer (Xplore® MC15 micro-compounder). 4.2 grams of the densified reduced graphene oxide granules was mixed with 6.8 grams of polypropylene at 200° C. for 10 mins at a screw speed of 75 rpm. The compound was then extruded out from the mixer as a strand and was cooled to room temperature in air.

### EXAMPLE 2

Preparation of densified wet granules for elastomer compounds: 80 grams of as produced rGO worms with a density of 0.005 gram/cm³ was added to a five-gallon plastic drum, and then 320 grams of deionized water was poured slowly on top of the rGO worm powder. The drum was tightly sealed and placed on a drum roller. The plastic drum was rolled for two hours at a roller speed of 38 rpm. The volume of the resulting densified rGO granules was at least 4 times less than the volume of the as produced rGO worms. The density of the densified rGO granules (including rGO worms and water) was 0.13 gram/cm³. The volume of the densified rGO granules was approximately 40 mL.

### EXAMPLE 3

Densified rGO Granules Masterbatch

Densified rGO granules, comprising rGO worms and water and prepared according to the procedure described in Example 2, were combined with natural rubber in a BR-1600 Banbury® mixer (“BR-1600”; Manufacturer: Farrel). The rubber used was SMR 20 natural rubber (Hokson Rubber, Malaysia), technical descriptions of which are found in Rubber World Magazine's Blue Book published by Lippincott and Peto, Inc. (Akron, Ohio, USA).

The walls and rotor of the mixer were pre-heated by setting the temperature control unit (TCU) to 105° C., and the mixer was set to a ram pressure of 2.8 bar. Two thirds of the natural rubber was added to the mixing chamber and masticated for 30 s at a rotor speed of 80 rpm. The rotor speed was reduced to 40 rpm and dosage bags of rGO granules were fed one at a time into the mixing chamber. After each bag was added, the ram was lowered to force incorporation of the bag into the masticated natural rubber. After all the bags were added, the final third of natural rubber was added and mixing was performed at 80 rpm. The thermomechanical mixing raised the temperature of the elastomer mix to greater than 100° C., causing the water component of the granules to boil off. To allow the escape of this water vapor, the ram was raised several times during the process. Antioxidant 12 (Akrochem, Akron, Ohio) was added when the mixer temperature reached 140° C., and mixing recommenced at 80 rpm. Once the mixer temperature reached 160° C., the mixture was discharged from the mixer and milled into sheets using a two-roll mill. The resulting masterbatch (“MB_E3”) had 8 phr rGOW and 1 phr Antioxidant 12.

### EXAMPLE 4

Dry CB+Densified rGO Granules Masterbatch

Densified rGO granules comprising rGO worms and water (prepared according to the procedure described in Example 2) were combined with natural rubber (SMR 20) and N375 carbon black according to the protocol described in Example 3, except after the rGO granules and all the natural rubber was added, mixing was performed for 30 s at 80 rpm followed by the addition of dry carbon black. Mixing recommenced at 80 rpm followed by the addition of Antioxidant 12 according to the protocol of Example 3. The resulting masterbatch (“MB_E4”) had 8 phr rGOW, 40 phr carbon black, and 1 phr Antioxidant 12.

### EXAMPLE 5

Wet CB+Densified rGO Granules Masterbatch

Wet carbon black was prepared by hand mixing equal weight of water and N375 carbon black in a bucket 12 h before mixing. The wet carbon black, densified rGO granules comprising rGO worms and water (prepared according to the procedure described in Example 2), SMR 20 natural rubber, and Antioxidant 12 were mixed according to the protocol described in Example 4. The resulting masterbatch (“MB_E5”) had 8 phr rGOW, 40 phr carbon black, and 1 phr Antioxidant 12.

### EXAMPLE 6

Densified rGO Granules/Oil Masterbatch

Densified rGO granules (300 g), produced according to the method described in Example 2, were blended with treated distillate aromatic extracted (TDAE) oil (60 g) in a 1 gallon plastic bottle. The bottle was tightly sealed and placed on a drum roller. The plastic bottle was rolled for two hours at a roller speed of 38 rpm. The resulting rGOW granules with oil were combined with natural rubber (SMR 20) and mixed according to the protocol described in Example 3. The resulting masterbatch (“MB_E6”) had 8 phr rGOW, 8 phr TDAE oil, and 1 phr Antioxidant 12.

### EXAMPLE 7

Densified rGO Granules+Isoprene Masterbatch

Densified rGO granules (100 g), produced according to the method described in Example 1, were blended with liquid isoprene rubber (40 g, KL-10 rubber, Kuraray Co., Ltd) in a 1 L plastic bottle. The bottle was tightly sealed and placed on a drum roller. The plastic bottle was rolled for two hours at a roller speed of 38 rpm. The resulting rGOW granules with isoprene were combined with natural rubber (SMR 20) and mixed according to the protocol described in Example 3. The resulting masterbatch (“MB_E7”) had 84 phr natural rubber, 16 phr liquid isoprene rubber, 8 phr rGOW, and 1 phr of Antioxidant 12.

### EXAMPLE 8

Rubber Compounds

Masterbatches MB_E3 to MB_E7, from Examples 3-7, respectively, were mixed with natural rubber (SMR 20), N375 carbon black, in a 3-stage process. The formulations of rubber compounds C3 to C7 (phr) are listed in Table 1.

TABLE 1
Formulations

| | C3 | C4 | C5 | C6 | C7 |
|---|---|---|---|---|---|
| Natural rubber (SMR-20) | 75 | 75.00 | 75.00 | 75 | 75 |
| MB_E3 | 27.25 | | | | |
| MB_E4 | | 37.25 | | | |
| MB_E5 | | | 37.25 | | |
| MB_E6 | | | | 29.25 | |
| MB_E7 | | | | | 27.25 |
| N375 CB | 40 | 30 | 30 | 40 | 40 |
| 6PPD | 1.50 | 1.50 | 1.50 | 1.50 | 1.50 |
| Antioxidant DQ Pellets | 0.50 | 0.50 | 0.50 | 0.50 | 0.50 |
| Zinc Oxide | 3.00 | 3.00 | 3.00 | 3.00 | 3.00 |
| Stearic Acid | 2.00 | 2.00 | 2.00 | 2.00 | 2.00 |

A first stage mixing process combined the ingredients listed in Table 1 in the BR-1600 mixer according to the protocol of Table 2 (time=cumulative time). “Smalls”=6 PPD, Antioxidant DQ, zinc oxide, stearic acid. “Antioxidant DQ”=polymerized 2,4-trimethyl-1,2-dihydroquinoline, Akrochem, Akron, Ohio; “6PPD”=N-(1,3-dimethylbutyl)-N’-phenyl-p-phenylenediamine. Mixing conditions were: TCU temperature=50° C., rpm=80 rpm; ram pressure=2.8 bar. After discharge, sheets were formed with a two-roll mill.

TABLE 2
Stage 1 Protocol

| | Mixer temp. | |
|---|---|---|
| Time (s) | (° C.) | Step Description |
| 0 | 50 | Add natural rubber and masterbatch |
| 30 | | Add 2/3 carbon black |
| 90 | 125 | Sweep/Add remaining carbon black |
| 120 | | Sweep |
| 180 | 140 | Sweep and add smalls |
| 210 | 145 | Sweep/Scrape |
| 300 | 160 | Adjust rpm to keep below 160° C., and |
| | | dump at 300 s. |

Second stage mixing protocol is shown in Table 3 (time=cumulative time), with mixing conditions TCU temperature=50° C., rpm=60 rpm; ram pressure=2.8 bar. After discharge, sheets were formed with a two-roll mill.

TABLE 3
Stage 2 Protocol

| | Mixer Temp | |
|---|---|---|
| Time (s) | (° C.) | Step Description |
| 0 | 50 | Add Stage 1 MB |
| 30 | | Add smalls |
| 90 | | Sweep |
| 180 | 160 | Dump at earlier of 180 s or 160° C. |

Curing agents (1.4 phr rubber accelerator BBTS powder (Akrochem)+1.9 phr sulfur) were combined with the stage 2 compounds (149.25 phr, except 151.25 phr for compound C6) according to the third-stage mixing protocol shown in Table 4 (time=cumulative time), with mixing conditions TCU temperature=50° C., rpm=60 rpm; ram pressure=2.8 bar.

TABLE 4
Stage 3 Protocol

| | Mixer temp | |
|---|---|---|
| Time (s) | (° C.) | Step Description |
| 0 | 50 | Add 1/2 Stage 1 MB/Curatives/ |
| | | Remaining Stage 1 MB |
| 30 | | Sweep |
| 90 | | Dump |

The resulting compounds were passed through a 2-roll mill to form sheets. Curing was performed at 150° C. over the time periods set forth in Table 5.

TABLE 5
Curing Times

| | C3 | C4 | C5 | C6 | C7 |
|---|---|---|---|---|---|
| Curing time for sheets thinner than 2 mm (minutes) | 10 | 10 | 10 | 10 | 12 |
| Curing time for sheets/parts thicker than 2 mm (min) | 20 | 20 | 20 | 20 | 22 |

The following tests were performed to obtain rubber properties:
Tensile properties (tensile stress at 100% elongation (M100), tensile stress at 300% elongation (M300), elongation at break, tensile strength). were evaluated by ASTM D412 (Test Method A, Die C) at 23° C., 50% relative humidity and at crosshead speed of 500 mm/min. Extensometers were used to measure tensile strain.
Max tan δ was measured with an ARES-G2 rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60° C. and at constant frequency of 10 Hz. Strain sweeps were run from 0.1-68% strain amplitude. Measurements were taken at ten points per decade and the maximum measured tan δ was reported.
Volume Resistivity (ohm·cm) was measured following ASTM D991 (Rubber Property Volume Resistivity of Electrically Conductive Antistatic Products). Equipment used included a Model 831 Volume Resistivity Test Fixture (Electro-tech Systems, Inc.; Perkasie, Pa.), designed to measure standard 3″×5″ samples, and an Acopian Power Supply, model P03.5HA8.5 with output 0-3500 V and up to 8.5 mA. Two Tenma multimeters (TENMA® 72-1055 Bench Digital Multimeter; Newark, Mississauga, Ontario) were used to measure voltage and current respectively for the 4-point resistance measurement setup as described in the test method.

Rubber properties are shown in Table 6.

TABLE 6
Rubber Properties

| Properties | C3 | C4 | C5 | C6 | C7 |
|---|---|---|---|---|---|
| rGOW (phr) | 2 | 2 | 2 | 2 | 2 |
| CB (phr) | 40 | 40 | 40 | 40 | 40 |
| Tensile strength | 29.53 | 29.00 | 30.03 | 34.17 | 20.25 |
| (MPa) | | | | | |
| Elongation at | 387 | 438 | 427 | 476 | 277 |
| break (%) | | | | | |
| M100 (MPa) | 5.99 | 5.19 | 5.38 | 5.19 | 6.72 |
| M300 (MPa) | 22.50 | 20.21 | 21.45 | 20.80 | |
| Tear strength, | 147.9 | 147.43 | 145.54 | 158.13 | 74.2 |
| die B (N/mm) | | | | | |
| G′ at 10% strain | 2.28 | 2.08 | 2.03 | 2.18 | 2.24 |
| Maximum tan δ | 0.132 | 0.118 | 0.122 | 0.146 | 0.089 |
| Volume | 1.51E+03 | 1.40E+03 | 2.43E+03 | 7.86E+02 | 8.54E+03 |
| resistivity | | | | | |
| (ohm.cm) | | | | | |

From the data of Table 6, it can be seen that compounds C3-C7 have suitable rubber properties.

### EXAMPLE 9

Rubber Compound Containing Wet CB and Densified rGO Granules

A compound (C9) was produced from densified rGO granules prepared according to the method of Example 2, wet N375 carbon black, and natural rubber in a 3-stage mixing process. The wet carbon black was formed by hand mixing equal weight of N375 carbon black and water in a bucket 12 h before mixing. Ingredients for the stage 1 mixing are shown in Table 7.

TABLE 7
Stage 1 ingredients

| Ingredients | Loading (phr) |
|---|---|
| Natural rubber (SMR-20) | 100 |
| rGOW (dry powder) | 2 |
| N375 CB (dry powder) | 40 |
| 6PPD | 1.50 |

Stage 1 mixing was performed in the BR-1600, with TCU temperature=85° C. and 2.8 bar ram pressure. The natural rubber was added to the mixing chamber and masticated for 30 seconds at a rotor speed of 105 rpm. The rotor speed was reduced to 40 rpm and dosage bags of densified rGO granules was fed one at a time to the mixing chamber. After each bag was added, the ram was lowered to force incorporation of the bag into the masticated natural rubber. After all the bags were added, three fourth (¾) of the wet carbon black was added to the mixer and mixed at 105 rpm until the mixer temperature reached 125° C. The remaining wet carbon black was added to the mixer and mixed at 105 rpm until the internal temperature reached 140° C. 6PPD was added to the mixer and mixing continued at 105 rpm and the compound discharged when the mixer temperature reached 160° C. Sheets were formed with a two-roll mill.

Stage 2 mixing was performed in the BR-1600 with the additives listed in Table 8.

TABLE 8
Stage 2 ingredients

| Ingredients | Loading (phr) |
|---|---|
| Stage 1 masterbatch | 143.5 |
| Antioxidant DQ | 0.5 |
| Zinc oxide | 3 |
| Stearic acid | 2 |

With a TCU temperature=50° C. and 2.8 bar ram pressure, the stage 1 masterbatch was masticated for 30 seconds at a rotor speed of 80 rpm followed by addition of remaining ingredients of Table 8. After mixing at 80 rpm for 150 s, the compound was discharged and milled into sheets using a two-roll mill.

Stage 3 mixing was performed in the BR-1600 with the stage 2 compound (149 phr) and curing additives (1.4 phr Cure Rite® BBTS rubber accelerator and 1.9 phr sulfur). With a TCU temperature=50° C. and 2.8 bar ram pressure, half of the stage 2 compound was added to the mixer, followed by curing agents and then the remainder of the stage 2 compound. Mixing was performed at 80 rpm for 90 s, after which the compound was discharged and milled into sheets using a two-roll mill. Curing was performed at 150° C. for 10 min.

Properties of the compound were obtained as described in Example 8 and listed in Table 9.

TABLE 9
Rubber Properties

| Properties | C9 |
|---|---|
| densified rGO granules (phr) | 2 |
| carbon black (phr) | 40 |
| Tensile strength (MPa) | 33.93 |
| Elongation at break (%) | 419 |
| M100 (MPa) | 5.67 |
| M300 (MPa) | 23.59 |
| Tear strength, die B (N/mm) | 128.62 |
| G′ at 10% strain (Mpa) | 2.033 |
| Maximum tan δ | 0.105 |
| Volume resistivity (ohm.cm) | 4.15E+03 |

From the data of Table 9, it can be seen that compound C9 has suitable rubber properties.

### EXAMPLE 10

Densified rGO Granules+HNBR Masterbatch

Densified rGO granules comprising rGO worms and water prepared according to the procedure described in Example 2 were combined with hydrogenated acrylonitrile butadiene rubber (HNBR) in the BR-1600 mixer. The HNBR was Zetpol® 3310 manufactured by Zeon Chemicals Corporation. Mixing was performed at TCU temperature=105° C. and 2.8 bar ram pressure. Two thirds of the HNBR was added to the mixing chamber and masticated for 30 s at a rotor speed of 80 rpm. The rotor speed was reduced to 40 rpm and dosage bags of rGO granules were fed one at a time into the mixing chamber. After each bag was added, the ram was lowered to force incorporation of the bag into the masticated natural rubber. After all the bags were added, the final third of natural rubber was added and mixing was performed at 80 rpm. The ram was raised several times to allow escape of water vapor. The masterbatch was discharged at a mixer temperature of 170° C., and milled into sheets using a two-roll mill. The resulting masterbatch had 2 phr rGOW.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1-11. (canceled)

12. A method for producing densified carbonaceous granules, the method comprising:
combining a carbonaceous material with a liquid, the carbonaceous material having a density of less than 0.01 g/cc and comprising particles having an average aspect ratio of greater than 3:1, the densified carbonaceous granules having a density at least five times greater than the density of the carbonaceous material.

13-39. (canceled)

40. Granules comprising:
reduced graphene oxide worm particles; and
at least 50% liquid, by weight.

41. The granules of claim 40 wherein the granules are free flowing.

42. The granules of claim 40 wherein the granules are non-contiguous.

43. The granules of claim 40 comprising additional particles selected from one or more of carbon nanotubes, graphite, carbon black, silica and clays.

44. (canceled)

45. The granules of claim 40 comprising at least 1.0% by weight of reduced graphene oxide worm particles.

46. The granules of claim 40 wherein the liquid comprises a water miscible solvent.

47. (canceled)

48. The granules of claim 40 wherein the liquid comprises water.

49. The granules of claim 40 wherein the granules have an average aspect ratio less than the average aspect ratio of the reduced graphene oxide worm particles of which the granules are comprised or less than 3:1.

50. The granules of claim 40 wherein the oxygen content, by weight, of the reduced graphene oxide worm particles is greater than 0.1% or less than 25%.

51. (canceled)

52. (canceled)

53. The granules of claim 40 wherein the granules may have an average diameter of 10 μm to 100 μm, 100 μm to 1 mm, 10 μm to 1 mm, 100 μm to 3 mm, 500 μm to 2 mm, 1 mm to 3 mm or 1 mm to 5 mm.

54. (canceled)

55. The granules of claim 40 wherein the granules have a density of greater than 0.02 g/cc.

56. A method of making a composite comprising:
mixing a polymer with a granule comprising reduced graphene oxide worm particles and at least 50% liquid, by weight; and
dispersing the reduced graphene oxide worm particles in the polymer to produce a polymer composite.

57. The method of claim 56 further comprising mixing in particles selected from carbon nanotubes, graphite, carbon black, silica and clay.

58. The method of claim 56 wherein the granules include one or more of carbon nanotubes, graphite, carbon black, silica and clay.

59. The method of claim 56 wherein the polymer is selected from elastomers, thermoplastics, polyurethanes, polysiloxanes and fluorinated polymers.

60-62. (canceled)

63. The method of claim 56 further comprising removing more than 50% of the liquid from the composite.

64. (canceled)

65. (canceled)

66. The method of claim 56 wherein the composite comprises reduced graphene oxide worms at a concentration of greater than 2% by weight.

67. (canceled)

68. The method of claim 56 wherein the concentration of reduced graphene oxide worms, by weight, in the composite is from 0.1% to 50%.

69-80. (canceled)
